(19) United States
(12) Patent Application Publication
(10) Pub. No.: US 2016/0034902 A1
(43) Pub. Date: Feb. 4, 2016

(54) INTELLIGENT CUSTOMER EXPERIENCE SYSTEM

(71) Applicant: Cierge LLC, Coppell, TX (US)

(72) Inventor: Davin Bernstein, Coppell, TX (US)

(21) Appl. No.: 14/567,799

(22) Filed: Dec. 11, 2014

Related U.S. Application Data
(60) Provisional application No. 62/031,239, filed on Jul. 31, 2014.

(51) Int. Cl. G06Q 30/00; G06Q 30/02

(52) U.S. Cl. CPC G06Q 30/01; G06Q 30/0205

(57) ABSTRACT

An intelligent system for managing a customer experience may consist of at least of a controller resident in a server that is positioned at a physical address. The controller can log a customer action and subsequently match the customer action with a customer profile. The controller may predict a customer satisfaction value and prompt an employee to engage in a staff action with a graphical user interface that is connected to the controller. The staff action can be selected by the controller in response to the customer satisfaction value to increase the customer's satisfaction and optimize the customer's experience.

### RELATED APPLICATION

The present application makes a claim of domestic priority under 35 U.S.C. §119(e) to copending U.S. Provisional Application No. 62/031,239 filed Jul. 31, 2014, the contents of which are incorporated by reference.

### SUMMARY

A system, in some embodiments, is configured with a controller resident in a server that is positioned at a physical address. The controller logs a customer action and subsequently matches the customer action with a customer profile. The controller predicts a customer satisfaction value and prompts an employee to engage in a staff action with a graphical user interface that is connected to the controller. The staff action is selected by the controller in response to the customer satisfaction value to increase at least one customer's satisfaction and optimize at least one customer's experience.

### BRIEF DESCRIPTION OF THE DRAWINGS

FIG. 1 is a block representation of an example computing system configured in accordance with various embodiments.

FIG. 2 shows a block representation of a computing device capable of being utilized in the computing system of FIG. 1.

FIG. 3 displays a flowchart of an example customer feedback scheme that may be conducted in accordance with various embodiments.

FIG. 4 illustrates a top perspective view of an example customer environment in which a customer satisfaction system may be employed in accordance with various embodiments.

FIG. 5 provides an example action prediction scheme carried out in accordance with various embodiments.

FIG. 6 is a flowchart of an example customer satisfaction routine that may be conducted in accordance with various embodiments.

### DETAILED DESCRIPTION

The proliferation of mobile computing devices, such as smartphones, tablet computers, and digital players, has provided the ability for people to stay connected to other people and digital content more readily. However, such mobile computing devices can distract people during times they are customers of a business. Distraction can impede and degrade the ability of a business to engage, learn, and customize service to a particular customer. For example, use of a mobile computing device during a dining experience at a bar or restaurant can minimize the interaction of a host, server, and other staff with the customer, which hinders the staffs ability to learn about the customer and customize the capabilities of the business to best suit the customer.

In a time before mobile computing devices, a maître d would learn the appearance, interests, and opinions of a customer through constructive conversation. Such conversation would allow the maître d to provide service customized to the customer, such as offering off-menu options, seating the customer near a window, and adding an extra olive to a beverage, without prompting by the customer. As a result, the customer would have an optimized experience that has a higher likelihood of customer satisfaction, repeat customer business, and increased customer sales volume. With mobile electronic devices occupying a customer's time and attention, interaction between business staff and the customer is limited and often distracted, which inhibits the ability of the staff to provide high customer satisfaction.

It is contemplated that through the tuned utilization of one or more mobile computing devices, a business can learn about the customer, much like a maître d would learn through conversation. Various embodiments employ a mobile computing device to determine a customer's proximity to a physical address, such as a restaurant, before at least one sensor detects and logs customer actions so that future customer actions can be predicted. The ability to sense a customer's actions, such as online activity and past restaurant reviews, can allow future actions to be predicted and altered by prompting business staff to conduct corrective actions. As a non-limiting example, a customer's food allergy can be detected from past online activity, the customer's rejection of a dish having the allergen is predicted, and staff is prompted to remove the allergen or ask the customer for another dish selection to alter the predicted rejection of the dish, which can increase customer satisfaction with minimal interaction between the business.

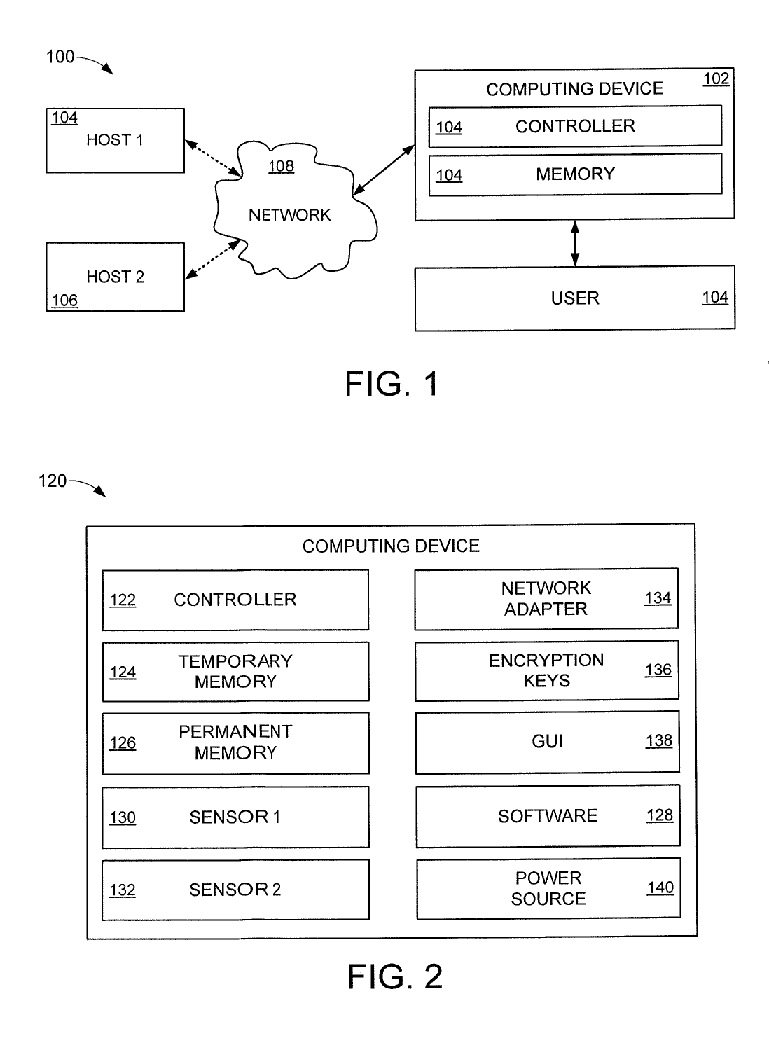

While tuned utilization of at least one computing device can be employed in a variety of business environments with an unlimited variety of components, various embodiments utilize the example intelligent customer satisfaction system 100 of FIG. 1 to detect, predict, and alter actions of a customer. The system 100 may have one or more computing devices 102. A computing device 102 may have fixed and mobile configurations that provide access to one or more remote hosts 104 and 106 via wired and wireless networks 108. It is contemplated that the computing device 102 is autonomous and is not connected to a remote host 104 or 106.

Regardless of whether or not the computing device 102 is configured to operate locally, remotely, or a combination thereof, at least one local controller 110, such as a microprocessor, can conduct a variety of operations that collect, process, and store data. For instance, the local controller 110 can execute applications, routines, and software that collect and generate data that the controller 110 selectively stores in local memory 112, such as temporary cache and permanent solid-state memory. Data stored locally can be transmitted to the remote hosts 104 and 106 for further storage and processing, which reduces the physical size and computing power requirements of the local controller 110 and memory 112 due to the supplementation of remote processing and storage capabilities.

The computing device 102 may be configured as any number of practical components. For example, a point-of-sale terminal, smartphone, tablet computer, camera, microphone, and monitor can each be an individual computing device 102 that can stand alone and be implemented with other computing devices 102 to detect customer actions and improve customer satisfaction. The computing device 102 may further be configured to operate in conjunction with one or more users 114 that can input data, direct device software execution, and utilize remote sensors and data sources via the network 108. The ability to employ the computing device 102 individually and collectively with remote hosts 104 and 106, such as other computing devices and servers, can optimize the collection of user and business data so the computing device 102 can efficiently increase the satisfaction of the user 114.

FIG. 2 displays a block representation of an example computing device 120 capable of being incorporated into the intelligent customer satisfaction system 100 of FIG. 1. The computing device 120 is contemplated as a fixed console, such as a point-of-sale terminal or server, but such configuration is not required or limiting as a computing device 120 can be mobile. The computing device 120 can function autonomously and selectively to collect business and customer data that are processed by at least one controller 122 and stored in at least one memory, such as the local temporary 124 and permanent 126 memories. The controller 122 may utilize one or more remote data storage locations and controllers to complement the capabilities of the local computing components of the computing device 120.

In accordance with assorted embodiments, the controller 122 employs at least first 128 and second 128 local sensors to collect data. The controller 122 may also collect data from any number of remote sensors independently and collectively with the local sensors 128 and 130. The type, size, and number of local sensors 128 and 130 are not limited, but can be different. For example, the first local sensor 128 can be one or more video cameras to monitor regions of a business at a physical address while the second local sensor 130 may be a microphone that can input data dictated by business staff and provided by customers directly. A local sensor may be configured to access one or more online networks, such as social networks, websites, forums, and applications, via a network adapter 132 to collect data pertaining to a customer.

Although data collected by the computing device 120 is in the public domain, the computing device 120 can employ at least one encryption key 134 to maintain the privacy and anonymity of data collected by the computing device. It is contemplated that video, voice, and online information pertaining to a customer is stored locally and encrypted by the encryption keys 134 prior to being sent to any remote hosts, such as hosts 104 and 106 of FIG. 1. The controller 122 may concurrently and independently operate one or more graphical user interfaces (GUI) 136 to display prompts, status, customer data, business data, and trends generated by at least one executed software 138 program. The controller 122 can dictate the execution, modification, and deactivation of various software 138 programs that can operate actively with engagement by a user and passively without confirmation or input of data by a user.

It is contemplated that one or more types of power sources 140, such as direct current batteries, alternating current transformers, and solar panels, can be attached and/or connected to the computing device 120 to provide operating power in fixed and mobile environments. It is noted that the various aspects of the computing device 120 are not required or limiting and can be configured in a variety of manners to provide business and customer data collection and processing that intelligently renders staff actions that can optimize customer satisfaction. The capabilities of the computing devices 102 and 120, respectively shown in FIGS. 1 and 2, may allow for active customer engagement that generates customer satisfaction indicia.

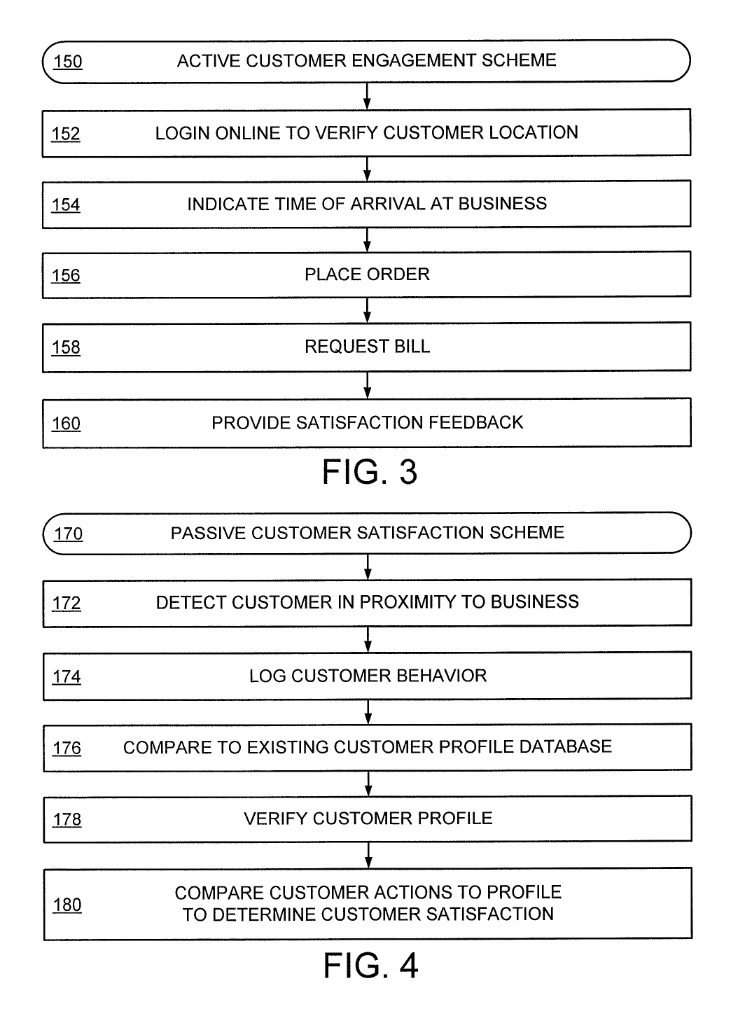

FIG. 3 conveys an example active customer engagement scheme 150 that may be carried out with one or more computing devices, such as a customer's smartphone and a business' point-of-sale terminal, in accordance with various embodiments. Step 152 may involve a customer logging in online to verify their physical location with respect to a business. The online login may be passive or active and provide real-time or predicted customer location. That is, step 152 may involve an application operating without customer input, such as a global position, or as an application that passes customer inputted data online, such as affirmative checking-in at a physical location verified by a global position. It is contemplated that a customer may make an appointment for being at a physical location without verification via global positioning.

Irrespective of how a customer logs in or affirms their physical location, step 154 can indicate a time of arrival at a business based on the customers verified or unverified location. Step 154 may be useful in determining if a customer is going to be early or late to an appointment as well as whether walk-in customers are more, or less, likely. The indicated time of arrival from step 154 can allow a business to anticipate high and low customer volume and take appropriate measures, such as increased staffing or marketing, to attract, engage, and satisfy the customer. Attracting a customer may lead to the placing of an order in step 156, whether the order is for pick-up, delivery, or consumed on-site.

The placing of an order in step 156 can lead to immediate or delayed billing of the customer. In a restaurant environment, a bill may be requested in step 158 at the customer's leisure while in a retail environment, a bill may be automatically requested in response to the customer's physical entrance into the business or contact with an order. At any time before, during, and after step 158, the customer may provide satisfaction feedback in step 160. In other words, the customer can input feedback in the form of words, expressions, and icons in step 160 at any time during scheme 150. The active participation of the customer in the various steps of scheme 150 can verify the intentions of the customer, but are often lacking enough depth and cohesion to provide satisfaction data that can be used to improve business service to the customer in the future.

For example, placing an order in step 156 without leaving feedback in step 160 or logging into a business' physical location in step 152 without ordering anything in step 156 does not provide enough data to adapt business practices to cater to that customer or better service other customers. As such, the use of computing devices, such as smartphones, can efficiently be used to collect business and customer data, but is often incomplete and not comprehensive enough to improve business service or a customer's satisfaction with business performance. Hence, various embodiments utilize one or more computing devices to supplement active customer data collection methods, such as scheme 150, with passive data collection to provide a more comprehensive understanding of a customer as a person and how a business engages that customer, which can be optimized to increase business performance wand customer satisfaction.

FIG. 4 provides an example passive customer satisfaction scheme 170 that may be carried out independently and in combination with other routines, applications, and schemes, such as scheme 150 of FIG. 3, in accordance with various embodiments. Initially, scheme 170 can passively detect a customer being in a predetermined proximity to a business, such as within a quarter mile, 100 feet, and within the bounds of the business. Passive detection in step 172 may consist of any number of sensors the continuously, sporadically, and routinely monitor physical locations, such as the entrance to the business, and online activity, such as checking into another location in close proximity the business, without the customer engaging the business directly. It is contemplated that step 172 is initiated with active customer engagement, like checking into the business, but such activity is not required.

With the business aware that a customer is in close proximity, step 174 can continuously and selectively log customer behavior. The behavior being logged can vary from a single action, such as facial expressions, to multiple different actions, like walking speed, volume of the customer's voice, fingerprints, height, and accent. The logged behavior can allow a computing device to identify a customer and verify a customer's presence. For example, a customer may actively or passively check in to a business, but not be actually present or remain at the business to purchase anything, which can convolute business efficiency and customer satisfaction data collected and generated by a computing device in response to a customer checking into the business.

It is contemplated that the customer behavior logged in step 174 can take into account the manner in which a customer enters the proximity of the business. That is, a customer may be detected by passive global positioning penetration of a predetermined geofence, such as a digital boundary set 50 feet from the entrance of the business, in step 172 and the walking speed of the customer into the business is the behavior logged in step 174. Any number of behaviors can be logged in step 174 before step 176 compares the customer's behaviors to a database of customer profiles. Step 176 can attempt to correlate detected customer behaviors with an existing customer profile statically and dynamically. For instance, step 174 may provide a single detected behavior, behavior tracked over time, and multiple different behaviors to provide step 176 with a heightened chance of identifying a customer as a customer profile.

A customer profile may be any volume of biographic data that can be compiled from past visits to a particular business, online opinions, online profiles, purchased marketing data, and demographic trends. The customer profile may be accessible and editable by the correlation of a customer with a customer profile can be verified in step 178 prior to step 180 comparing past and future customer actions with the customer profile to passively determine the customer's satisfaction. Verification of a customer with a customer profile may consist of additional customer behaviors being logged, such as types and numbers of behaviors that previously were not logged.

With a customer verified with an existing customer profile, step 180 can utilize existing biographic, opinion, and demographic trends to interpret future customer behaviors in terms of satisfaction. In other words, access to a customer profile can increase the accuracy and sensitivity of customer satisfaction measurements, which can be used to increase business efficiency, the customer's satisfaction, and the profitability of the business. It is noted that various embodiments and examples are directed to a customer engaging a restaurant for services, but such relationship is not required as a passive customer satisfaction system can be practiced in any number of retail, commercial, industrial, and online business environments.

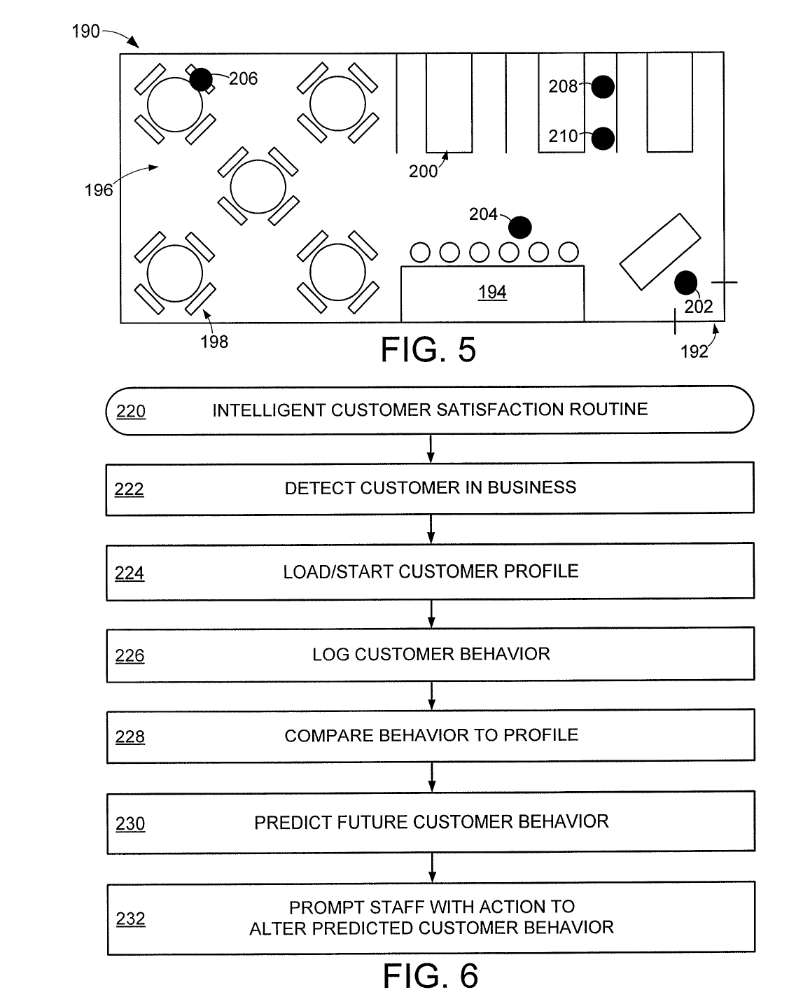

FIG. 5 displays a top view block representation of a portion of an example restaurant 190 in which an intelligent customer satisfaction system may be incorporated in accordance with various embodiments. The restaurant 190 can be characterized into assorted regions that are not required or limiting. For example, an entrance region 192 can have at least one entry, a bar region 194 can have one or more types of food and beverage stations that serve products, such as alcoholic beverages or ice cream, and a dining region 196 can have one or more different types of seating, such as four person tables 198 and six person booths 200. It is noted that the restaurant 190 can be configured differently than that shown in FIG. 5 with more, different, and fewer regions to provide food, beverage, and entertainment to a customer.

When a customer is within proximity of the entry region 192, one or more sensors can detect the customer's presence. A sensor may consult an online global positioning application, the customer's online reservation, and the customer's active logging into the restaurant 190 to detect the customer is present in and around the physical address of the business. It is contemplated that software, such as a mobile computing device application, can be activated by the customer at some time and that software can continuously and routinely identify the global position of the customer. Such software communication with a computing device of the restaurant 190 can be passive due to the customer not actively engaging the restaurant 190, but instead carrying a mobile computing device that engages the restaurant 190 autonomously.

In some embodiments, mobile computing device software can efficiently allow a customer to be identified and a customer profile to be verified and utilized by the restaurant 190. It is contemplated that the mobile computing device software can access one or more aspects of the customer's mobile computing device to provide biographic, economic, and opinion data that can be used to identify the satisfaction of the customer. As such, the customer's mobile computing device acts as a sensor to collect and provide customer data to the restaurant 190, which allows the customer's profile to be more accurate and robust.

In the event mobile computing device software is being used, the restaurant 190 can be notified that the customer is within a predetermined proximity of the restaurant 190, such as 1 mile. Proximity with the restaurant 190 may correspond with marketing information being distributed to the mobile computing device, such as a coupon, free offer, and recent customer review, in an effort to draw the customer into the restaurant 190. It can be appreciated that access to the customer's profile allows marketing instances to be customized to the customer's interests and opinions, which increase the chance of success for the marketing material.

The use of mobile computing device software can further allow the restaurant 190 to take proactive actions, such as making a beverage, preparing an appetizer, and prompting a valet, to conform with known and predicted customer expectations and standards. Software operating on a customer's mobile computing device can provide customer data, such as device usage time, to indicate the level of interest or distraction the customer has while in the restaurant 190. Some embodiments configure the mobile computing device software to generate, store, and provide a customer profile, which can be more comprehensive for a customer due to a wider variety of parameters being monitored over a greater time compared to a customer profile generated from data collected while the customer is at the restaurant 190.

The restaurant's customer profile may be updated at any time with information accessed from the mobile computing device customer profile. The ability to update the restaurant's customer profile with customer data pertaining to activity outside the restaurant 190 can allow the restaurant 190 to more efficiently understand the customer's behavior and customize service to maximize customer satisfaction. In the same way, the mobile computing device and restaurant customer profiles can be continuously and routinely updated, which allows the customer profile to adapt to changing and evolving customer interests and behaviors.

It is noted that a customer profile may not always be present for a customer. Hence, various embodiments are directed at passively generating a new customer profile. Although a mobile computing device of a customer can be used to collect customer data, such as biographic information like age and ethnicity, any number of sensors can be utilized to detect and compile biographic and economic customer information while the customer is within the physical address of the restaurant 190. For example, cameras, microphones, and manually entered data, such as data entered by a hostess or manager, can detect a customer's presence at point 202. The customer's face, build, ethnicity, hair, and fashion can be sensed and compared to an existing customer profile database to correlate the customer to a customer profile.

In the event no customer profile can be found, a temporary new customer profile can be started as additional customer data is compiled in an effort to correlate the customer with an existing customer profile. A template customer profile may be employed with a new customer profile that has a variety of parameters, such as interests, food preferences, and patience, based on collected visual customer information obtained at point 202. That is, the customer's face can be recognized to correspond with a particular demographic and ethnicity that has a biographic template of observed trends that can be used to populate a new customer profile and service the customer with increased satisfaction compared to having no biographic information.

A restaurant 190 computing device may employ collected biographic information about a new customer to engage in online research in an effort to compile customer data that can populate a customer profile. For instance, a photo of a new customer's face can be used to search for public online profiles and databases that can supply customer information, such as education, place of residence, occupation, and marital status. The information collected via online research can allow a customer profile to more accurately interpret behaviors of the customer at least in terms of the customer's satisfaction.

For example, information collected online, as well as trends compiled from other restaurant customers with similar biographic data, can indicate various preferences, such as claustrophobia, which can be used by the restaurant 190 to discern the maximum potential customer satisfaction corresponding with being seated in the bar, such as point 204, a table, such as point 206, inside a booth, such as point 208, and outside a booth, such as point 210. A new or existing customer profile may also allow the restaurant 190 to seat the customer in a location close to, or far away from, windows, the kitchen, and the bar upon various interests and preferences of the customer, which can lead to heightened energy, less distraction, and optimized satisfaction. Through the generation and utilization of a customer profile, various restaurant 190 actions, like specials offered and customer wait times, can be employed to identify the status and efficiency of the restaurant 190. It is understood that active customer feedback may complement a customer profile and allow the restaurant 190 to organize orders, hurry staff, and conform to the customer's expressed request.

However, utilizing a customer profile and active customer feedback can be reactive, which may not be sufficient to prevent or correct customer dissatisfaction. Accordingly, various embodiments employ a customer profile and passive customer feedback to proactively engage in actions that can intelligently establish and maintain high levels of customer satisfaction. In a non-limiting example, local and/or remote controller can utilize a known or anonymous customer profile and at least one predictive algorithm to predict a customer satisfaction value and prompt an employee with a staff action via a GUI to increase the customer satisfaction value. The predictive capabilities of an intelligent customer experience system can automatically sense a customer's face, gestures, voice, ordering preferences, and other actions to provide one or more staff actions that proactively prevent bad customer actions, like yelling, or proactively trigger good customer actions, like smiling.

FIG. 6 is a flowchart of an example intelligent customer satisfaction routine 220 that can be conducted in accordance with assorted embodiments. The routine 220 begins by detecting one or more customers in step 222. Detection is not limited to a physical or online presence and can consist of active and passive customer activity, such as logging in, making a reservation, and crossing a geofence in proximity to the business.

Step 224 can use the detection of a customer in step 222 to load or start a customer profile. As discussed, various customer actions and behavior can be detected and processed to identify and verify a customer in relation to a customer profile. As a non-limiting example, a new customer profile can be utilized and discarded once customer behaviors logged in step 226 verify the customer's identity and customer profile. It is contemplated that a customer profile may not have enough information to accurately interpret a customer's behavior, such as when the customer is in a different mood or with different people than when previous profile data was compiled. Hence, step 228 compares currently observed customer behavior with a customer profile to determine if the profile is an accurate representation of the customer.

Some embodiments can configure a customer profile to store multiple different mood and group subsets for a given customer to allow for accurate behavior interpretation in diverse dining conditions, such as after the customer's favorite sports team loses or in-laws are dining with the customer. Regardless of the volume and accuracy of the data in a customer profile, step 230 can process currently observed customer behavior with an algorithm to predict future customer behavior. The algorithm utilized in step 230 is not static or limited to a particular number of reference points, such as three logged customer criteria, like voice volume, height, and accent. However, step 230 can consist, in various embodiments, of demographic, psychological, social, and economic models and trends. With the utilization of a variety of models, a customer's interests, biographical information, and past logged customer feedback can accurately predict the customer's reaction and satisfaction in response to a range of different dining conditions.

Although recognizing positive customer reactions and behaviors to a dining experience can be constructive for a restaurant, the identification of conditions that will likely degrade customer satisfaction are more constructive. For example, if a waiter notes a customer is acting impatient in step 226, step 230 can predict that food being delivered anytime after 5 minutes from the time of the order will result in customer displeasure. As another example, observed irritability from volatile fluctuations in the customer's volume, inflection, and tone can render a prediction from step 230 that presentation of a dessert menu will result in a reduction in customer satisfaction.

The prediction of a customer's satisfaction and behavior in step 230 can correspond with a one or more corrective staff actions to be generated in step 232 to mitigate customer dissatisfaction and behaviors that can cause other guests displeasure. Step 232 may prompt one or more members of a staff to conduct in a variety of actions, such as conversation, suggestions, and preparation of a bill, that can maintain or correct customer satisfaction. For instance, step 232 may prompt a waiter to discuss the customer's favorite hobby or sports team to calm the customer, an appetizer or dessert may be provided free of charge, and a manager may be prompted to allow the customer to voice negative feedback before acknowledging the customer's feelings.

It is noted that a diverse number of staff actions can be conducted individually, successively, and concurrently to manage a customer with treatment customized to maximize the customer's satisfaction. It is contemplated that step 230 may predict little change in customer satisfaction, but step 232 can prompt staff actions to learn more about the customer in an effort to better establish and maintain high levels of satisfaction in the future. For example, step 230 may predict an instance where the customer profile is insufficient to reliably correct a customer behavior and prompt a staff member to engage in conversation about a particular topic with one or more questions that are recorded or entered to make the customer profile more complete.

Step 232 may further encompass the logging of one or more customer reactions to prompted staff actions. Customer reactions may be logged manually by an employee into a GUI and/or automatically by one or more sensors in the business. For example, step 232 can prompt the employee to ask the customer a question and the employee subsequently logs the customer's reaction while a voice sensor detects the customer's tone and an optical sensor detects the customer's facial expressions, gestures, and posture to provide a comprehensive customer reaction. Such a comprehensive customer reaction can be used to increase the accuracy of the system's predictive algorithm, the customer's profile, the customer's enjoyment, and the customer's likelihood of returning.

Through the various steps of routine 220, a customer profile may be generated, updated, and consulted to predict a customer's future behavior and satisfaction. A variety of active and passive customer feedback means may be employed to identify a customer's current level of satisfaction, which can be employed to increase the accuracy of predicted customer satisfaction. The ability to generate a comprehensive customer profile and utilize that profile to predict customer behavior can allow any number of staff actions to be conducted to ensure the customer has a relatively high satisfaction level. Additionally, the prediction of customer reactions to dining conditions can allow a restaurant to customize and optimize service to maximize the customer's repeat business, tips, active feedback, opinion, and amount of goods purchased.

Various embodiments focus on service provided through the use of the intelligent system. With pre-set electronic ordering means that don't intelligently adapt to a customer, the customer can ask the waiter to refresh drinks, but can't conduct certain functions, such as ordering a specific item. Some embodiments change staff action suggestions on the next visit for a customer to optimize the customer's experience, if appropriate. Hence, an intelligent system can dynamically alter service instruction by providing real time dynamic guidance to hospitality servers that is intended to increase customer loyalty to a business that uses this service. In assorted embodiments, a restaurant can tailor their standard service guidance in software accessed by a local or remote controller to provide an experienced server who is not familiar with a customer with tips and suggestions that are highly specific to a guest who has been in the business at least once before. It is contemplated that various embodiments filter customers that are outside a physical address by likelihood of coming into the place of business. In other words, the intelligent customer experience system can focus on potential customers with direct and indirect marketing to provide “triage” and focus on the people most likely to present themselves for service

With various embodiments providing customer specific staff actions in response to predicted behavior and actions, the staff get optimized service suggestions that are personalized to the customer, an alert when the customer wants a specific service, and the ability to research customer history, which is predictive to customer preferences, both specific to the individual and situation. The intelligent customer experience system can provide a customer with a way to request service from their mobile device, such as a phone, that prompts staff to engage in verbal and/or non-verbal actions customized to the customer based on an existing customer profile compiled from observed and predicted customer behavior.

It is contemplated that the various embodiments of hardware and software can be used to develop business intelligence and loyalty services that can optimize service. It should be noted that the various embodiments of the present disclosure are not restricted to face-to-face customer interactions and the prediction and alteration of a customer's actions can be practiced over a wired or wireless network. The various embodiments may further be practiced by non-enterprise businesses as well as enterprise businesses.

Assorted embodiments compile a large database of observable customer actions that are utilized to predict future customer interests, needs, and actions. For example, a variety of customer spoken phrases, body language cues, and facial expressions can be used to predict what the customer wants on a future dining experience, which can be characterized as a “service suggestion module.” It is contemplated that a variety of different analytics, metrics, models, and trends can be compiled, accessed, and updated over time to optimize the identification of a customer and prediction of future customer interests and actions through one or more algorithms. The development of unique algorithms, in some embodiments, can accurately predict what customers want based on prior orders and observable behaviors, such as a fast or slow eater, attention hungry person, and introvert versus extrovert, to provide customized and optimized service through cues to the staff.

In various embodiments, the identification of a customer and prediction of future interests and actions can be utilized to identify new and existing customers for VIP status. That is, the various means to identify and predict customer actions can identify all customers that actually meet and likely will meet thresholds for spending and visit frequency. Those identified customers can be given VIP status that grants heightened sensitivity to satisfaction and attention from the staff. VIP status may, in some embodiments, alter the algorithm used to predict behavior towards the use of more individualized, and less generic, analytics and models in an effort to maximize the amount of money spent along with the customer's satisfaction.

As a non-limiting example, a customer that is a regular diner at a restaurant, and has a verified customer profile, can be matched to a pattern of predicted customer profiles that increases the attention of the staff as to when the customer is arriving, what the customer likes to discuss, what the customer likes to eat, and how quickly the customer is served. Such heightened attention can proactively anticipate what the customer wants and service those wants without prompting by the customer.

What is claimed is:

1. A method comprising:
logging a customer action with a controller resident in a server positioned at a physical address;
matching the customer action with a customer profile accessed by the controller;
predicting a customer satisfaction value in response to the customer action with the controller; and
prompting an employee with a graphical user interface connected to the controller to engage in a staff action in response to the customer satisfaction value.

2. The method of claim 1, wherein the staff action is based on an algorithm accessed by the controller.

3. The method of claim 1, wherein the controller logs a plurality of customer actions or requests upon entrance of a customer into the physical address.

4. The method of claim 3, wherein the controller constructs a plurality of user profiles for in response to the plurality of customer actions or requests.

5. The method of claim 4, wherein the controller identifies a customer based on a match with a user profile of the plurality of user profiles.

6. The method of claim 1, wherein the predicted customer satisfaction value is increased in response to the staff action.

7. The method of claim 1, wherein the staff action comprises a verbal comment directed by the controller.

8. The method of claim 1, wherein the staff action comprises a physical interaction between the employee and a region proximal a customer.

9. The method of claim 1, wherein the staff action comprises a service provided to a customer.

10. The method of claim 1, wherein the controller evaluates at least three different logged criteria to predict the customer satisfaction value and the resulting staff action.

11. An apparatus comprising a controller resident in a server and connected to a graphical user interface and at least one sensor at a physical address, the controller adapted to log a first customer action at the physical address and predict a second customer action, the controller prompting an employee with the graphical user interface to engage in a staff action to alter the predicted second customer action.

12. The apparatus of claim 11, wherein the at least one sensor comprises a video camera.

13. The apparatus of claim 12, wherein the controller identifies a customer with facial recognition.

14. The apparatus of claim 12, wherein the controller identifies a customer by recognizing a gesture of the customer.

15. The method comprising:
sensing a first customer action at a physical address with a sensor;
predicting a second customer action with a controller resident in a server positioned at the physical address;
prompting an employee with a graphical user interface connected to the controller to engage in a first staff action in response to the customer satisfaction value; and
sensing a third customer action to evaluate an effectiveness of the first staff action.

16. The method of claim 15, wherein the employee inputs a first customer reaction subsequent to the first staff action being performed.

17. The method of claim 16, wherein the controller alters at least one customer profile in response to the first customer reaction.

18. The method of claim 16, wherein the controller provides a second staff action in response to the first customer reaction, the second staff action being different than the first staff action.

19. The method of claim 16, wherein a sensor detects a second customer reaction subsequent to the first staff action being performed, the second customer reaction being different than the first customer reaction.

20. The method of claim 19, wherein the controller prompts a second staff action in response to the first and second customer reactions.
